(19) United States
(12) Patent Application Publication
(10) Pub. No.: US 2010/0290687 A1
(43) Pub. Date: Nov. 18, 2010

(54) Apparatus And Methods For Displaying An Elastic Image Using An Ultrasound System

(76) Inventors: Dong-Kuk SHIN, Seoul (KR); Jong-Sik Kim, Seoul (KR)

Correspondence Address: JONES DAY, 222 EAST 41ST ST, NEW YORK, NY, 10017, US

(21) Appl. No.: 12/779,722

(22) Filed: May 13, 2010

(30) Foreign Application Priority Data
May 14, 2009 (KR) 10-2009-0042088

(51) Int. Cl. G06K 9/00

(52) U.S. Cl. 382/131

(57) ABSTRACT

Disclosed is an apparatus for generating an elastic image that includes an interpolation unit configured to generate a first data set using ultrasound images obtained at a maximum pressure and at a minimum pressure; an image generating unit configured to generate a pyramid image using the first data set; a map generating unit configured to generate a motion map using the pyramid image; a displacement calculating unit configured to calculate a displacement based on the motion map; and a display unit configure to display an elastic image using the calculated displacement.

### CROSS-REFERENCE TO RELATED APPLICATION

This application claims the benefit of Korean Patent Application No. 10-2009-0042088, filed on May 14, 2009, in the Korean Intellectual Property Office, the disclosure of which is incorporated herein by reference.

### BACKGROUND OF THE INVENTION

1. Field of the Invention

The present invention relates to apparatus and methods for displaying an elastic image using an ultrasound system.

2. Description of the Related Art

Ultrasound-based medical imaging techniques, such as ultrasonography, may be used to visualize subcutaneous body structures including muscles, tendons, and internal organs. Ultrasonography typically employs a probe having one or more transducers that send acoustic pulses into a material. The pulses are reflected back to the probe as they impinge upon materials having different acoustical impedances. A subcutaneous body structure may be imaged based on the strength of the received pulses and time elapsed between transmission and receipt of the pulses.

Previously-known ultrasound systems may have difficulty in generating an image of a lesion such as cancer or a tumor existing in soft tissue because lesions generally do not have a well defined boundary. Still, various techniques for imaging lesions are known in the art, such as interpolating ultrasound data using, for example, an attenuation coefficient, a non-linear parameter (B/A), a sound velocity distribution, or a modulus of an elasticity image. However, these techniques may not produce an image having adequate resolution.

Elastography is a non-invasive technique used to detect or classify lesions using stiffness or strain images of target tissue. It has been observed that the stiffness or strain that can be induced within tissue is a function of the elasticity of the tissue, and that generally tumors or other tissue abnormalities display increased stiffness and experience less strain when subjected to a predetermined force. As a result, when an outside force is applied to a target area of tissue, the cancerous growth or tumor deforms less than the surrounding soft tissue. This phenomenon may be employed to compare the elastic properties of a target tissue area using ultrasonic imaging at different applied stresses, a technique referred to as “elastography.” The resulting image, called an elastogram, is expected to provide more information about the elastic properties of the target tissue and better resolution of the tumor boundary than previously-known ultrasound systems and offer significant breakthroughs in diagnosing cancer.

Elastography may be applicable to fields that visualize tissue, e.g., detection and classification of breast cancer and prostate cancer, skin biopsy, monitoring of a kidney transplant, monitoring of cancer treatment using high intensity focused ultrasound (HIFU), and the like.

### SUMMARY OF THE INVENTION

An aspect of the present invention provides an apparatus and method for displaying an elastic image using a calculated displacement based on a three-dimensional (3D) direction of motion.

Another aspect of the present invention also provides an apparatus and method for displaying an elastic image by calculating a 3D direction of motion of an ultrasound image using a plurality of sequential data to minimize the number of calculations required and provide a fast processing rate.

According to an aspect of the present invention, an apparatus for generating an elastic image includes an interpolation unit configured to generate a first data set using ultrasound images obtained at a maximum pressure and at a minimum pressure; an image generating unit configured to generate a pyramid image using the first data set; a map generating unit configured to generate a motion map using the pyramid image; a displacement calculating unit configured to calculate a displacement based on the motion map; and a display unit configure to display an elastic image using the calculated displacement.

The apparatus may include an information extracting unit to extract motion information from subsequent ultrasound images obtained at a maximum pressure and at a minimum pressure using the generated motion map, wherein the displacement calculating unit is configured to compute displacement using the extracted motion information.

The information extracting unit may predict at least one of a motion direction or a maximum motion value using the generated motion map.

The map generating unit may calculate, by using the generated pyramid image, a motion direction of at least one of an X-axis, a Y-axis, or a Z-axis with respect to the first data, and generates the motion map based on the calculated motion direction.

The image generating unit may generate the pyramid image to have a multi-level structure, and determines a depth of the multi-level structure based on at least one of a process rate apparatus and a resolution of the motion direction of the first data. The first data may include at least three sequential frames.

The apparatus may be included in an ultrasound image diagnostic system.

According to an aspect of the present invention, a method of generating an elastic image includes interpolating ultrasound image data obtained at a maximum pressure and at a minimum pressure to generate first data; generating a pyramid image using the first data; generating a motion map using the pyramid image; calculating a displacement based on the motion map; and displaying an elastic image using the displacement.

The method may include extracting motion information from subsequent ultrasound images obtained at a maximum pressure and at a minimum pressure using the motion map, wherein calculating of the displacement calculates the displacement using the extracted motion information.

Extracting of the motion information may include predicting at least one of a motion direction or a maximum motion value using the generated motion map.

Generating the motion map may include calculating a motion direction of at least one of an X-axis, a Y-axis, and a Z-axis with respect to the first data; and generating the motion map based on the calculated motion direction.

Generating of the pyramid image may include generating the pyramid image to have a multi-level structure; and determining a depth of the multi-level structure based on at least one of a process rate apparatus and a resolution of the motion direction of the first data.

The method may be implemented using at least one medium that includes computer readable instructions for implementing the method.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating exemplary points at which data is obtained during movement of a three-dimensional probe across tissue.

FIG. 2 is a block diagram illustrating an exemplary ultrasound apparatus for displaying an elastic image according to the present invention.

FIG. 3 illustrates an exemplary pyramid image generated by the image generating unit.

FIG. 4A illustrates an exemplary motion map generated by the map generating unit.

FIG. 4B illustrates a magnified version of the motion map of FIG. 4A.

FIG. 5 illustrates exemplary data after motion information was extracted using the information extracting unit.

FIG. 6 illustrates an ultrasound signal generated by the probe before compressing the target area, e.g., an area of a human body, and after compressing the target area using the pressure applicator.

FIG. 7 is a flowchart illustrating a method for displaying an elastic image using an ultrasound apparatus according to the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Embodiments of the present invention include an ultrasound apparatus used to display an elastic image of a target area, e.g., a subcutaneous lesion and surrounding soft tissue. The ultrasound apparatus may include a three-dimensional (3D) probe, e.g., a 3D mechanical probe or a multi-dimension electronic array probe. The probe is placed on a subject's epidermis near the target area to obtain data regarding the subcutaneous structures to be imaged. The probe may be configured to be moved in an up and down manner using a freehand scheme to obtain the data, or may obtain data by being oscillated right and left.

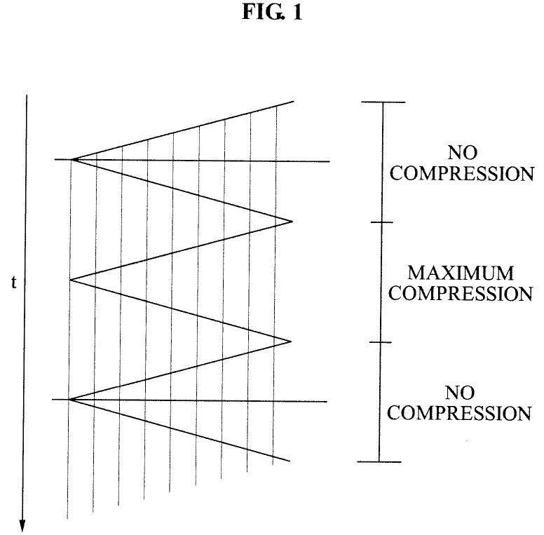

FIG. 1 is a diagram illustrating exemplary points at which data is obtained during movement of a three-dimensional probe across tissue. In FIG. 1, the zigzag line represents data obtained at points on the tissue as the probe is first moved from right to left across the tissue, and then returned to its starting position relative to time (t). The next timewise zigzag line represents movement of the probe across the same tissue but which tissue is now compressed. The third timewise zigzag line corresponds to movement through the same range as the original motion, and again with the tissue in an uncompressed state. In a preferred embodiment, the probe obtains delayed data which may be corrected through interpolation and by obtaining data in a relatively narrow time interval. This may prevent aliasing that may occur when one-dimensional (1D) data is obtained based on three-dimensional data.

In FIG. 1, each of the nine vertical lines represent a plurality of data. The plurality of data may be interpolated using the ultrasound apparatus. In a preferred embodiment, a single motion of the probe from left to right or right to left may be referred to as “minimum compression” and one full left to right to left or right to left to right motion may be referred to as “maximum compression.”

The probe may be moved vertically in the same manner that a mechanical-swept 3D probe may be moved right and left, and also, may be employed to deform the target area using a pressure applicator.

The pressure applicator may be separate from the probe and may be included in the ultrasound apparatus or system. The pressure applicator may be configured to apply a predetermined amount of pressure to the target area. The degree of the pressure may be determined by selecting one of a predetermined pressure levels with or without a sensor. The elasticity of the tissue in the target area may be determined based on the degree of tissue deformation resulting from pressure applied by the pressure applicator, as further described below. The elasticity may be displayed using the ultrasound apparatus.

In a preferred embodiment, the probe may be applied to the epidermis using a freehand scheme, which may result in inconstant pressure as applied by the pressure applicator. However, a user of the ultrasonic apparatus may obtain data using a freehand scheme by repeatedly providing and removing pressure to the target area. The elasticity of the target area may be determined using a relative normalization value for each single period of interpolation because pressure applied by the pressure applicator may be different every time.

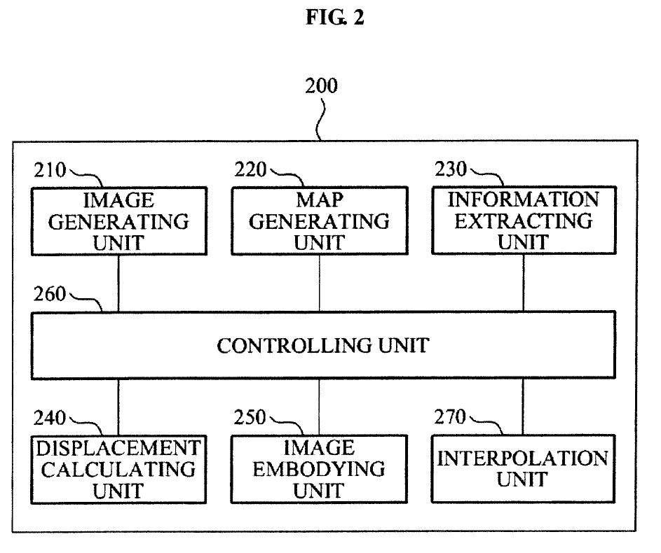

FIG. 2 is a block diagram illustrating an exemplary ultrasound apparatus for displaying an elastic image according to the present invention.

The ultrasound apparatus 200 may include an image generating unit 210, a map generating unit 220, an information extracting unit 230, a displacement calculating unit 240, a display unit 250, a controlling unit 260, and an interpolation unit 270.

The image generating unit 210 may be configured to generate a pyramid image using data received from the probe (not illustrated). The probe may be operatively coupled to the image generating unit 210 directly or via the controlling unit 260. In a preferred embodiment, the data includes In-phase and Quadrature-phase (IQ) data including at least three sequential frames or radio frequency (RF) data.

The image generating unit 210 is configured to generate a pyramid image having a multi-level structure, and to determine the depth of the multi-level structure based on the processing rate of the ultrasound apparatus and/or the resolution of the data received from the probe.

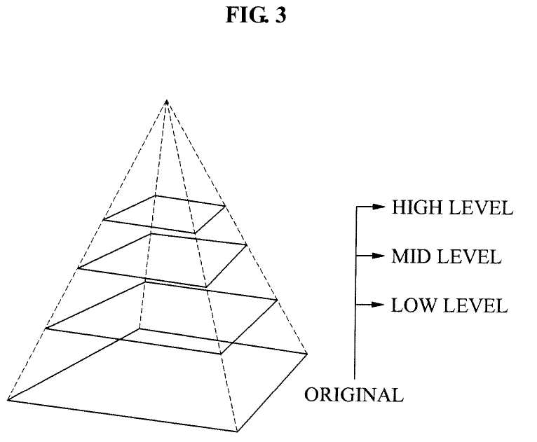

FIG. 3 illustrates an exemplary pyramid image generated by the image generating unit 210. For example, when the depth of the multi-level structure is determined to be three, the pyramid image is generated using at least three sequential frames, e.g., high level, mid level, and low level frames.

The image generating unit 210 may be configured to generate the pyramid image using an appropriate amount of data received from the probe to decrease the number of calculations required by the map generating unit 220 to generate a motion map. The data received from the probe and the generated pyramid image may be transmitted to the map generating unit 220 via the controlling unit 260.

The map generating unit 220 may be configured to generate a motion map using the generated pyramid image. The motion map may be used to search for a direction of motion based on basic information in the data received by the probe, e.g., the location of an edge of a lesion. The motion map may include a degree of motion (motion value), a motion direction, a motion speed, and the like. The map generating unit 220 may be configured to calculate a direction of motion of the data received from the probe along the X (horizontal)-axis, Y (vertical)-axis, and/or Z (temporal)-axis using the generated pyramid image and to generate the motion map based on the calculated motion direction.

The generated pyramid image may include, for example, three images: ‘image A,’ ‘image B,’ and ‘image C.’ The map generating unit 220 may be configured to calculate a direction of motion of the data received from the probe along the horizontal axis, vertical axis, and/or temporal axis for ‘image A,’ ‘image B,’ and/or ‘image C’ using a block matching scheme or a correlation scheme. A motion map may be generated using the calculated directions of motion which minimizes the number of calculations required to generate the motion map.

In a preferred embodiment, the accuracy of the motion map (3D motion direction map) generated by the map generating unit 220 may increase as the number of sequential frames in the data from the probe increases. Accordingly, the image generating unit 210 may be configured to determine the number of sequential frames based on the relationship between the processing rate of the ultrasound apparatus 200 and the accuracy of the motion map.

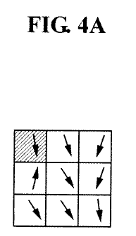

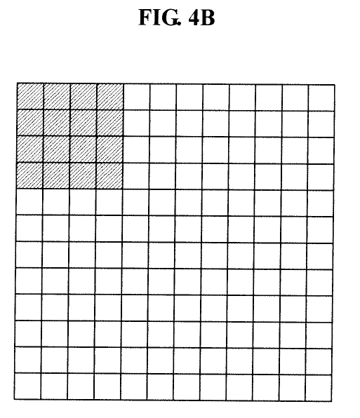

FIG. 4A illustrates an exemplary motion map generated by the map generating unit 220. The arrows within the motion map represent a direction of motion of the data obtained from the probe using the generated pyramid from the image generating unit 210. The motion map as illustrated is two-dimensional (2D), although a three-dimensional motion map may be generated based on the 2D motion map by calculating a direction of motion of the data from the probe along a third axis, e.g., the temporal axis.

FIG. 4B illustrates a magnified version of the motion map of FIG. 4A. Each square within the motion map of FIG. 4A is represented by sixteen squares in FIG. 4B.

Referring back to FIG. 2, the information extracting unit 230 may be configured to extract information received from the map generating unit 220 via the controlling unit 260 regarding the direction of motion of the data in the generated motion map. The data from the map generating unit may include a frame, e.g., temporal IQ input cine data.

The information extracting unit 230 may be configured to predict the direction of motion and the maximum motion value (a degree of motion) of the data from the motion map generated by the map generating unit 220. In a preferred embodiment, the information extracting unit 230 may be configured to extract information received from the map generating unit 220 via the controlling unit 260 regarding the maximum motion value of the data in the generated motion map.

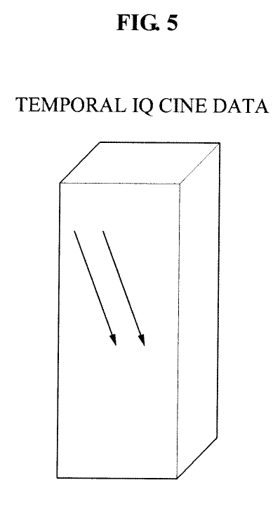

FIG. 5 illustrates exemplary data after motion information was extracted using the information extracting unit 230.

Referring back to FIG. 2, the displacement calculating unit 240 may be configured to calculate the displacement of the target area before and after pressure is applied to the target area via the pressure applicator using the extracted motion information received from the information extracting unit 230 via the controlling unit 260. The displacement may be a 3D displacement. The displacement may be calculated by applying the extracted motion information to a cross/auto correlation scheme, and the like. The displacement calculating section 240 may be further configured to calculate the elasticity of the tissue in the target area based on the calculated displacement of the target area.

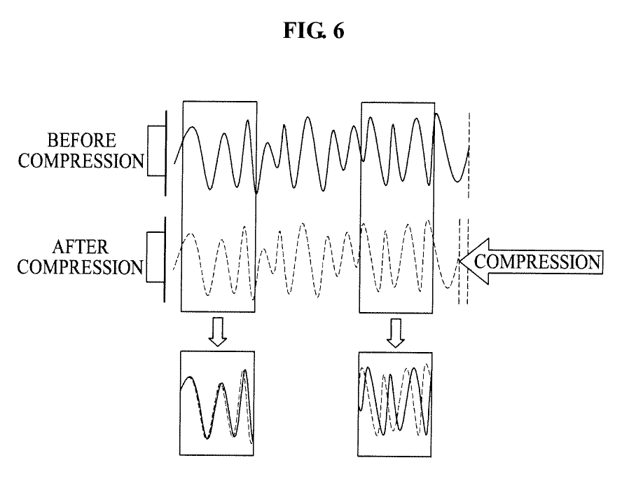

FIG. 6 illustrates an ultrasound signal generated by the probe before compressing the target area, e.g., an area of a human body, and after compressing the target area using the pressure applicator. The displacement calculating unit 240 may be configured to measure the correlation between the ultrasound signals before and after compression and may calculate the movement between the signals before and after compression based on the measured correlation to determine the elasticity of the target area. As described above, the pressure applicator may be separate from the probe and may be included within the ultrasound apparatus 200.

Referring back to FIG. 2, the display unit 250 may be configured to display an elastic image using the calculated displacement from the displacement calculating unit 240 via the controlling unit 260. A corresponding color may be assigned to an image for display based on a degree of the calculated displacement. The display unit 250 may be configured to process the elastic image using post processing to increase the quality of the displayed elastic image.

The controlling unit 260 may be configured to control the image generating unit 210, the map generating unit 220, the information extracting unit 230, the displacement calculating unit 240, the display unit 250, and the interpolation unit 270.

The ultrasound apparatus 200 may further include an interpolation unit 270. The interpolation unit may be configured to interpolate and generate a first data set using ultrasound images obtained from the probe at a maximum pressure and at a minimum pressure. A pyramid image may be generated using the interpolated data.

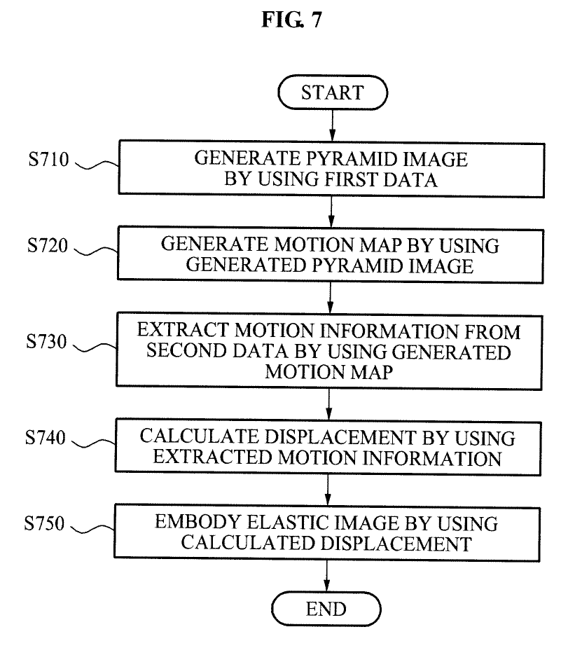

FIG. 7 is a flowchart illustrating a method for displaying an elastic image using an ultrasound apparatus according to the present invention. The method may be performed using the ultrasound apparatus 200 of FIG. 2.

First, a first data set is generated using ultrasound images obtained from the probe at a maximum pressure and at a minimum pressure. The first data set may be interpolated.

Next, at step S710, a pyramid image is generated using the generated first data. The pyramid image may be generated with a multi-level structure, and the depth of the multi-level structure may be determined based on the processing rate of the ultrasound apparatus and/or the resolution of the data received from the probe.

Then, at step S720, a motion map is generated using the generated pyramid image. A direction of motion of the data received from the probe along the X (horizontal)-axis, Y (vertical)-axis, and/or Z (temporal)-axis may be calculated using the generated pyramid image, and a motion map based on the calculated motion direction may be generated.

Next, at step S730, information received from the motion map regarding the direction of motion of the data in the generated motion map is extracted. The direction of motion and the maximum motion value (a degree of maximum motion) of the data from the generated motion map may be predicted. Information received from the generated motion map regarding the maximum motion value of the data in the generated motion map may also be extracted.

Then, at step S740, a displacement of the target area before and after pressure is applied via the pressure applicator is calculated using the extracted motion information. The displacement may be calculated by applying the extracted motion information to a cross/auto correlation scheme and the like.

Next, at step S750, an elastic image based on the calculated displacement is displayed. The elastic image may be displayed by assigning a corresponding color to an image according to a degree of the calculated displacement.

The method according to the above-described exemplary embodiments of the present invention may be recorded onto a computer-readable media. Additionally, program instructions to implement various steps in the method by a computer may be recorded onto the computer-readable media. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. Apparatus for generating an elastic image comprising:
an interpolation unit configured to generate a first data set using ultrasound images obtained at a maximum pressure and at a minimum pressure;
an image generating unit configured to generate a pyramid image using the first data set;
a map generating unit configured to generate a motion map using the pyramid image;
a displacement calculating unit configured to calculate a displacement based on the motion map; and
a display unit configure to display an elastic image using the calculated displacement.

2. The apparatus of claim 1, further comprising:
an information extracting unit to extract motion information from subsequent ultrasound images obtained at a maximum pressure and at a minimum pressure using the generated motion map,
wherein the displacement calculating unit is configured to compute displacement using the extracted motion information.

3. The apparatus of claim 2, wherein the information extracting unit predicts at least one of a motion direction or a maximum motion value using the generated motion map.

4. The apparatus of claim 1, wherein the map generating unit calculates, by using the generated pyramid image, a motion direction of at least one of an X-axis, a Y-axis, or a Z-axis with respect to the first data, and generates the motion map based on the calculated motion direction.

5. The apparatus of claim 1, wherein the image generating unit generates the pyramid image to have a multi-level structure, and determines a depth of the multi-level structure based on at least one of a process rate apparatus and a resolution of the motion direction of the first data.

6. The apparatus of claim 1, wherein the first data includes at least three sequential frames.

7. An ultrasound image diagnostic system including the apparatus of claim 1.

8. A method of generating an elastic image comprising:
interpolating ultrasound image data obtained at a maximum pressure and at a minimum pressure to generate first data;
generating a pyramid image using the first data;
generating a motion map using the pyramid image;
calculating a displacement based on the motion map; and
displaying an elastic image using the displacement.

9. The method of claim 8, further comprising:
extracting motion information from subsequent ultrasound images obtained at a maximum pressure and at a minimum pressure using the motion map,
wherein the calculating of the displacement calculates the displacement using the extracted motion information.

10. The method of claim 9, wherein the extracting of the motion information comprises:
predicting at least one of a motion direction or a maximum motion value using the generated motion map.

11. The method of claim 8, wherein generating the motion map comprises:
calculating a motion direction of at least one of an X-axis, a Y-axis, and a Z-axis with respect to the first data; and
generating the motion map based on the calculated motion direction.

12. The method of claim 8, wherein the generating of the pyramid image comprises:
generating the pyramid image to have a multi-level structure; and
determining a depth of the multi-level structure based on at least one of a process rate apparatus and a resolution of the motion direction of the first data.

13. At least one medium comprising computer readable instructions implementing the method of claim 8.
